(19) United States
(12) Patent Application Publication
(10) Pub. No.: US 2025/0131441 A1
(43) Pub. Date: Apr. 24, 2025

(54) SYSTEMS AND METHODS OF FRAUD PREVENTION FOR CROSS-BORDER TRANSACTIONS

(71) Applicant: Capital One Services, LLC, McLean, VA (US)

(72) Inventors: Jeffrey RULE, Chevy Chase, MD (US); Jeffrey Carlyle WIEKER, Falls Church, VA (US); Paul FORT, Westbury, NY (US)

(73) Assignee: Capital One Services, LLC, McLean, VA (US)

(21) Appl. No.: 18/918,974

(22) Filed: Oct. 17, 2024

Related U.S. Application Data
(60) Provisional application No. 63/545,025, filed on Oct. 20, 2023.

(51) Int. Cl. G06Q 20/40

(52) U.S. Cl. CPC G06Q 20/4016

(57) ABSTRACT

A system for performing cross-border transactions is provided. The system includes a computer server including a memory and a processor. The server is configured to: receive, from a first entity, transaction information of a transaction, wherein the transaction information is included in an International Organization for Standardization (ISO)-supported file; generate a transaction identifier for the transaction; transmit, to the first entity, the transaction identifier for the transaction; perform an anti-money laundering (AML) check based on the transaction information; apply a machine learning model to identify a pattern based on the transaction information; write the AML check and the pattern to the ISO-supported file; receive the transaction identifier from a second entity; and transmit a transaction approval message to the second entity based on the AML check and the pattern.

### CROSS-REFERENCE TO RELATED APPLICATIONS

This application claims the priority of U.S. Provisional Patent Application No. 63/545,025, filed on Oct. 20, 2023, the contents of which are incorporated herein by reference in their entirety.

### FIELD OF THE INVENTION

The present disclosure relates generally to data security, and more particularly, to systems and methods of fraud prevention for cross-border transactions.

### BACKGROUND

Data security and transaction integrity are of critical importance to businesses and consumers. Fraudulent actors will frequently try to exploit vulnerabilities in data storage, data transmission, and user authentication to perform fraudulent transactions. Fraudulent transactions can be very costly and disruptive for businesses and consumers, and attempts by fraudulent actors to perform fraudulent transactions or other fraudulent activity are increasing.

Cross-border transactions occurring between one or more parties on different sides of a border (e.g., a border between one or more different countries) can be subject to a variety of risk from fraudulent actors. On such issue, particularly for cross-border transactions such as in correspondent banking and overseas remittances, is the ability to understand and assess risk across all of the parties within the transaction chain. This can not only cause data security and fraud vulnerabilities but also can create exposure to money laundering activities.

These and other deficiencies exist. Accordingly, there is a need to provide systems and methods that overcome these deficiencies to prevent fraud for cross-border transactions.

### SUMMARY

Aspects of the disclosed technology include systems and methods of performing cross- border transactions.

Embodiments of the present disclosure provide a system for performing cross-border transactions. The system includes a computer server including a memory and a processor. The server is configured to: receive, from a first entity, transaction information of a transaction, wherein the transaction information is included in an International Organization for Standardization (ISO)-supported file; generate a transaction identifier for the transaction; transmit, to the first entity, the transaction identifier for the transaction; perform an anti-money laundering (AML) check based on the transaction information; apply a machine learning model to identify a pattern based on the transaction information; write the AML check and the pattern to the ISO-supported file; receive the transaction identifier from a second entity; and transmit a transaction approval message to the second entity based on the AML check and the pattern.

Embodiments of the present disclosure provide a method for performing cross-border transactions. The method includes: receiving, from a first entity, transaction information of a transaction, wherein the transaction information is included in an International Organization for Standardization (ISO)-supported file; generating a transaction identifier for the transaction; transmitting, to the first entity, the transaction identifier for the transaction; performing an anti-money laundering (AML) check based on the transaction information; applying a machine learning model to identify a pattern based on the transaction information; writing the AML check and the pattern to the ISO-supported file; receiving the transaction identifier from a second entity; and transmitting a transaction approval message to the second entity based on the AML check and the pattern.

Embodiments of the present disclosure provide a non-transitory, computer-readable medium comprising instructions for performing cross-border transactions that, when executed on a computer arrangement, cause the computer arrangement to perform actions comprising: receiving, from a first entity, transaction information of a transaction, wherein the transaction information is included in an International Organization for Standardization (ISO)-supported file; generating a transaction identifier for the transaction; transmitting, to the first entity, the transaction identifier for the transaction; performing an anti-money laundering (AML) check based on the transaction information; applying a machine learning model to identify a pattern based on the transaction information; writing the AML check and the pattern to the ISO-supported file; receiving the transaction identifier from a second entity; and transmitting a transaction approval message to the second entity based on the AML check and the pattern.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

FIG. 1 is a diagram of a system of fraud prevention for cross-border transactions according to an example embodiment.

FIG. 2 is a diagram of sequential interactions between components of the system in FIG. 1 according to an example embodiment.

FIG. 3 is a flow chart of a method of fraud prevention for cross-border transactions according to an example embodiment.

FIG. 4 is a flow chart of a method of fraud prevention for cross-border transactions according to an example embodiment.

FIG. 5 is a flow chart of a method of fraud prevention for cross-border transactions according to an example embodiment.

FIG. 6 is a flow chart of a method of fraud prevention for cross-border transactions according to an example embodiment.

FIG. 7 is a diagram of a system of fraud prevention for cross-border transactions according to an example embodiment.

### DETAILED DESCRIPTION OF EXAMPLE EMBODIMENTS

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

The described features and teachings of the embodiments may be combined in any suitable manner. A person of ordinary skill in the art will recognize that the embodiments may be practiced without one or more of the specific features and teachings of an embodiment. In other instances, additional features and teachings may be recognized in certain embodiments that may not be present in all embodiments. A person of ordinary skill in the art will understand that the described features and teachings of any embodiment can be interchangeably combined with the features and teachings of any other embodiment.

The payment processing industry is changing from fixed length format for financial transaction card originated interchange messaging under the ISO 8583 standard to an Extensible Markup Language (XML) based format under the ISO 20022 standard. Under the XML-based standard, more data can be sent for better authorization decision-making and better personalization of transaction cards. One of the biggest vulnerabilities in cross-border transactions, particularly in correspondent banking and overseas remittances, is the ability to understand and assess risk across all of the parties within the transaction chain. Example embodiments of the present disclosure provide systems and methods of fraud prevention for cross-border transactions using the XML-based ISO 20022 standard. The present disclosure can allow each party in the transaction chain to add fraud information to the XML-based ISO 20022 message, and confirm information from elsewhere in the chain to reduce fraud.

There can be many parties involved in a cross-border transaction in addition to an originating agent (e.g., a sending bank). This can include a money transfer operator (e.g., correspondent banks) and a disbursing agent (e.g., a foreign bank). The originating agent and the disbursing agent can be facilitating firms such as payment service providers (PSPs), corporate payment service providers (e.g., payment/collection on behalf of POBO/COBO)), and/or third-party payment service providers (TPP PSP).

In some examples, TPP PSPs can be authorized PSPs that are able to access customer accounts and conduct transactions on behalf of businesses. TPP PSPs is emerged from an open banking framework and are designated in the revised payment services directed (PSD2). A correspondent bank can be a financial institution that provides services to another bank, usually in another country, and acts as an intermediary or agent, facilitating wire transfers and remittances.

In some examples, the originating agent can provide initial authentication and funds collection from a sender, and the originating agent can be a bank or PSP. The originating agent can have direct contact with the sender and can collect information, including without limitation Internet Protocol (IP) address, geo-location, unique device identification (ID) that started remittance with the originating agent, browser language, account data (e.g., if the sender has an account with the originating agent they can share their personal identification information data), name, email, phone number (including how recently these have been updated), recent account changes and account age, historical transactions and velocity metrics, size of recent remittances, whether this is a recurring transfer, know your client (KYC) due diligence at regular intervals and rate customers based on the risk they pose. The collected information can be included in the new ISO 20022 standard.

The money transfer operator has ongoing relationships with the originating agents and the disbursing agents. They can track the reliability and fraud rates associated with these entities and can pass this information in the ISO 20022 transactions.

In some embodiments, the money transfer operator may need to communicate with banks in countries that may not support ISO 20022. In this case, the money transfer operator can create an aggregate risk score from the known data and pass this information onto the older and more limited financial information standards.

The disclosed systems herein can be an end-to-end systems enabled for ISO 20022, and the money transfer operator can add robust data including: anti-money laundering (AML) checks (e.g., the money transfer operator can perform AML checks to reduce their exposure to money launderers that often disguise illegally obtained funds as legitimate income using remittances), and fraud identification (e.g., the money transfer operator can look for patterns indicating mule accounts, unusual transaction volumes, transactions inconsistent with customer profiles, and customers with a past suspicious activity/transaction report (SAR/STR) marked history).

In some embodiments, machine learning models can be used to detect and report anomalous patterns against customers' peer groups and past transaction history and provide a flag on these accounts as well as using the fraud data provided in ISO 20022 transactions. The disbursing agent has the best knowledge of the conditions in the overseas location.

They can provide information on previous suspicious remittance to the money receiver. The disbursing agent can perform entity link analysis. The entity link analysis can be an impactful way of preventing remittance fraud. Such analysis can help discover any hidden relationships between parties that seem disparate but are somehow interrelated based on demographic profiles. The entity link analysis also helps analyze transaction patterns and detect mule account schemes, thus preventing money laundering. These relationships resulting from the entity link analysis can be written back to the ISO 20022 standard. Each money receiver can be assigned an ongoing risk score based on the entity link analysis.

All of the above data can be shared throughout the transaction chain and can cause the money transfer to be slowed or stopped. If a fraud against the money sender is suspected the money transfer can be paused and the money sender contacted to confirm the transaction. Because of better data, recovered funds can also be return to the money sender without the typically long and cumbersome processes, potentially via multiple banks and jurisdictions. This can reduce operational costs.

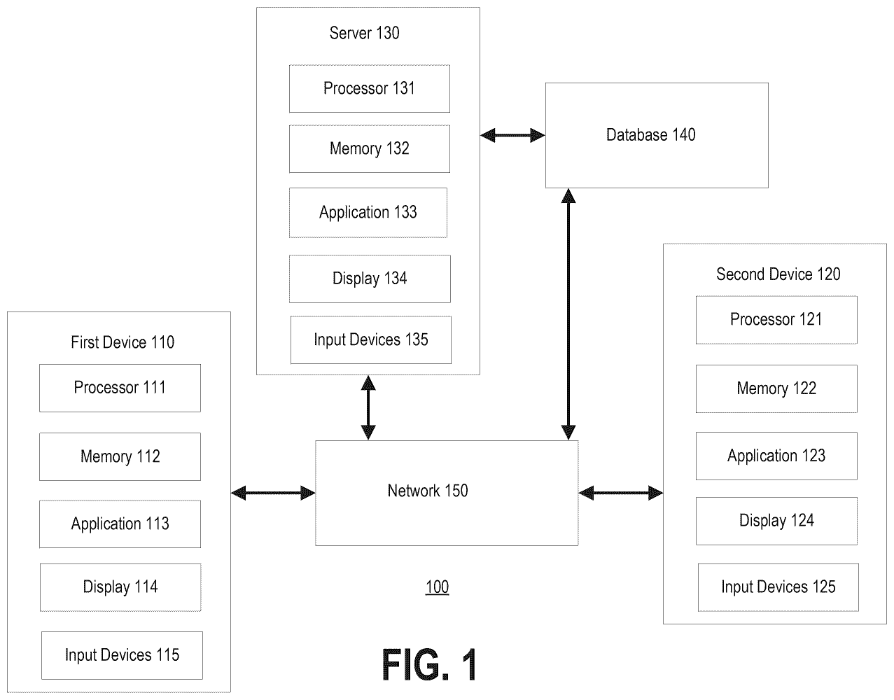

FIG. 1 illustrates a system 100 of fraud prevention for cross-border transactions according to an example embodiment. As further discussed below, the system 100 may include a first device 110, a second device 120, a server 130, and a database 140 in communication using a network 150. Although FIG. 1 illustrates single instances of the components, the system 100 may include any number of components.

The first device 110 may be associated with an originating agent with which a transaction is conducted by a user. Alternatively, the first device 110 may be associated with the user, for example, a mobile phone of the user on which the user can perform the transaction.

The first device 110 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The first device 110 may include a processor 111, a memory 112, and an application 113. The processor 111 may be a processor, a microprocessor, or other processor, and the first device 110 may include one or more of these processors. The processor 111 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the first device 110 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 112 may be configured to store one or more software applications, such as the application 113, and other data, such as user's financial account information.

The application 113 may comprise one or more software applications comprising instructions for execution on the first device 110. In some examples, the first device 110 may execute one or more applications, such as software applications, that enable, for example, network communications with one or more components of the system 100, transmit and/or receive data, and perform the functions described herein. Upon execution by the processor 111, the application 113 may provide the functions described in this specification, specifically to execute and perform the steps and functions in the process flows described herein. For example, the application 113 may be executed to perform authenticating the user or send an authentication request of authenticating the user. The application 113 may also be executed to perform processing transactions of a user. Such processes may be implemented in software, such as software modules, for execution by computers or other machines. The application 113 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The first device 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the first device 110 that is available and supported by the first device 110, such as a touch-screen, keyboard, mouse, cursor-control device, microphone, digital camera, video recorder or camcorder. These devices may be used to enter information and interact with the software and other devices described herein.

The second device 120 can be used by a disbursing agent. For example, the second device 120 may be a backend server associated with the disbursing agent.

The second device 120 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The second device 120 may include a processor 121, a memory 122, an application 123, a display 124, and input devices 125. The processor 121 may be a processor, a microprocessor, or other processor, and the second device 120 may include one or more of these processors. The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the second device 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as private and personal information.

The application 123 may comprise one or more software applications comprising instructions for execution on the second device 120. In some examples, the second device 120 may execute one or more applications, such as software applications, that enable, for example, network communications with one or more components of the system 100, transmit and/or receive data, and perform the functions described herein. Upon execution by the processor 121, the application 123 may provide the functions described in this specification, specifically to execute and perform the steps and functions in the process flows described herein. Such processes may be implemented in software, such as software modules, for execution by computers or other machines. The application 123 may provide GUIs through which users may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The second device 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the second device 120 that is available and supported by the second device 120, such as a touch-screen, keyboard, mouse, cursor-control device, microphone, digital camera, video recorder or camcorder. These devices may be used to enter information and interact with the software and other devices described herein such as selecting an option of creating an online account with the merchant.

The server 130 may be associated with a money transfer operator, such as a financial institution, and can be configured to communicate with the first device 110 and/or the second device 120.

The server 130 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 130 may include a processor 131, a memory 132, and an application 133. The processor 131 may be a processor, a microprocessor, or other processor, and the server 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the server 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as user's financial account information and the contactless card information.

The application 133 may comprise one or more software applications comprising instructions for execution on the server 130. In some examples, the server 130 may execute one or more applications, such as software applications, that enable, for example, network communications with one or more components of the system 100, transmit and/or receive data, and perform the functions described herein. Upon execution by the processor 131, the application 133 may provide the functions described in this specification, specifically to execute and perform the steps and functions in the process flows described herein. Such processes may be implemented in software, such as software modules, for execution by computers or other machines. The application 133 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the server 130 that is available and supported by the server 130, such as a touch-screen, keyboard, mouse, cursor-control device, microphone, digital camera, video recorder or camcorder. These devices may be used to enter information and interact with the software and other devices described herein.

The database 140 may be one or more databases configured to store date, including without limitation, private information of users, financial accounts of users, and transactions of users. The database 140 may comprise a relational database, a non-relational database, or other database implementations, and any combination thereof, including a plurality of relational databases and non-relational databases. In some examples, the database 140 may comprise a desktop database, a mobile database, or an in-memory database. Further, the database 140 may be hosted internally by the server 130 or may be hosted externally of the server 130, such as by a server, by a cloud-based platform, or in any storage device that is in data communication with the server 130.

The system 100 may include one or more networks 150. In some examples, the network 150 may be one or more of a wireless network, a wired network or any combination of wireless network and wired network, and may be configured to connect the first device 110, the second device 120, the server 130, and the database 140. For example, the network 150 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 150 may include, without limitation, telephone lines, fiber optics, IEEE Ethernet 902.3, a wide area network, a wireless personal area network, a LAN, or a global network such as the Internet. In addition, the network 150 may support an Internet network, a wireless communication network, a cellular network, or the like, or any combination thereof. The network 150 may further include one network, or any number of the exemplary types of networks mentioned above, operating as a stand-alone network or in cooperation with each other. The network 150 may utilize one or more protocols of one or more network elements to which they are communicatively coupled. The network 150 may translate to or from other protocols to one or more protocols of network devices. Although the network 150 is depicted as a single network, it should be appreciated that according to one or more examples, the network 150 may comprise a plurality of interconnected networks, such as, for example, the Internet, a service provider's network, a cable television network, corporate networks, such as credit card association networks, and home networks. The network 150 may further comprise, or be configured to create, one or more front channels, which may be publicly accessible and through which communications may be observable, and one or more secured back channels, which may not be publicly accessible and through which communications may not be observable.

In some examples, communications between the first device 110, server 130, and second device 120 using the network 150 can occur using one or more front channels and one or more secure back channels. A front channel may be a communication protocol that employs a publicly accessible and/or unsecured communication channel such that a communication sent to the first device 110, server 130, and/or second device 120 may originate from any other device, whether known or unknown to the first device 110, server 130, and/or second device 120, if that device possesses the address (e.g., network address, Internet Protocol (IP) address) of the first device 110, server 130, and/or second device 120. Exemplary front channels include, without limitation, the Internet, an open network, and other publicly-accessible communication networks. In some examples, communications sent using a front channel may be subject to unauthorized observation by another device. In some examples, front channel communications may comprise Hypertext Transfer Protocol (HTTP) secure socket layer (SSL) communications, HTTP Secure (HTTPS) communications, and browser-based communications with a server or other device.

A secure back channel may be a communication protocol that employs a secured and/or publicly inaccessible communication channel. A secure back channel communication sent to the first device 110, server 130, and/or second device 120 may not originate from any device, and instead may only originate from a selective number of parties. In some examples, the selective number of devices may comprise known, trusted, or otherwise previously authorized devices. Exemplary secure back channels include, without limitation, a closed network, a private network, a virtual private network, an offline private network, and other private communication networks. In some examples, communications sent using a secure back channel may not be subject to unauthorized observation by another device. In some examples, secure back channel communications may comprise Hypertext Transfer Protocol (HTTP) secure socket layer (SSL) communications, HTTP Secure (HTTPS) communications, and browser-based communications with a server or other device.

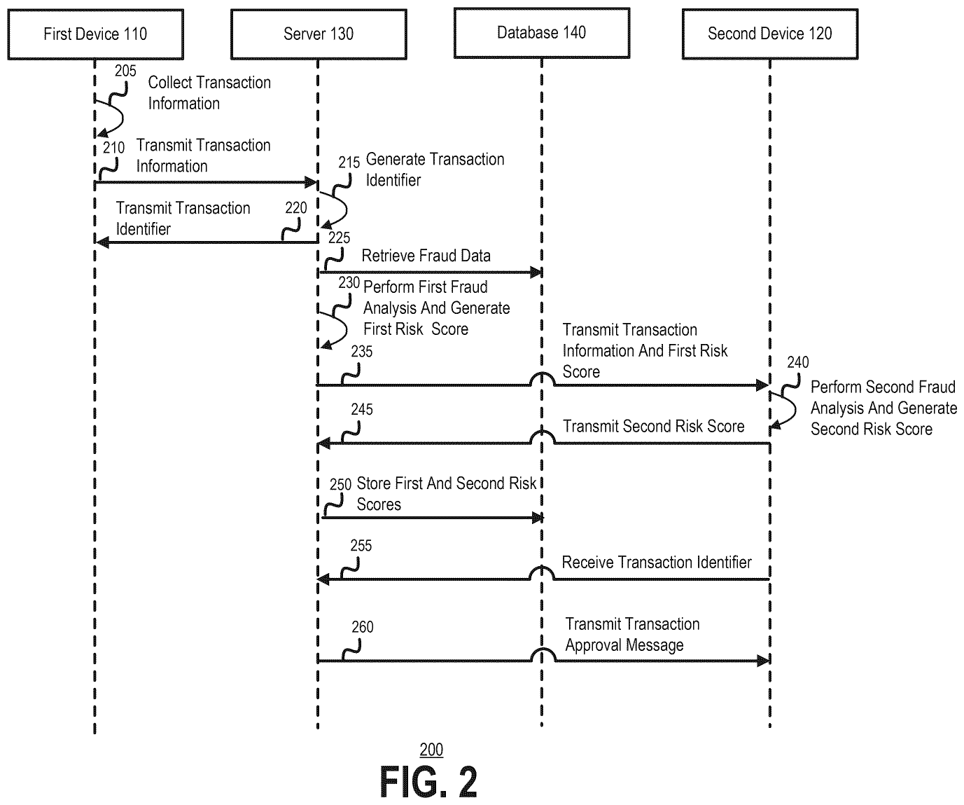

FIG. 2 illustrates an example diagram 200 of sequence interaction between the components of the system 100 according to an example embodiment. FIG. 2 may reference the same or similar components as those illustrated in FIG. 1, including a first device, a server, a database, and a second device.

When a user (e.g., a money sender) wants to transfer cross-border money to a money receiver in another country, at step 205, the first device 110 associated with an originating agent can collect the money and transaction information associated with the transaction and the money sender. The transaction information can include, for example, name and geographic location of the money sender, phone number and identification of the money sender, name and geographic location of the money receiver, phone number and identification of the money receiver, device identification of the first device 110, IP address of the first device 110, browser language of the first device 110.

At step 210, the first device 110 may transmit the transaction information to the server 130 associated with a money transfer operator. The transaction information can be written in an ISO 20022 standard message.

At step 215, the server 130 may generate a transaction identifier. The transaction identifier is used to identify the transaction and the transaction information.

At step 220, the server 130 may transmit the transaction identifier to the first device 110. The money sender may receive the transaction identifier from the first device 110 and notify the money receiver of the transaction identifier.

At step 225, the server 130 may retrieve from the database 140 fraud data associated with the money sender and/or the money receiver, and past transactions of the money sender and/or the money receiver.

At step 230, the server 130 may perform a first fraud analysis based on the transaction information received from the first device 110 and the fraud data retrieved from the database 140. The first fraud analysis can include performing an anti-money laundering (AML) check; and looking for patterns indicating mule accounts, unusual transaction volumes, transactions inconsistent with customer profiles, and customers with a past SAR/STR marked history. The first fraud analysis may use machine learning (ML) models to detect and report anomalous patterns against customers' peer groups and past transaction history and provide a flag on these accounts as well as using the fraud data provided in the ISO-20022 transaction message. The server 130 may generate a first risk score for the money sender and the transaction based on the first fraud analysis. The server 130 may store the first fraud analysis results and the first risk score on the database 140.

At step 235, the server 130 may further write the first fraud analysis results and the first risk score into the ISO 20022 standard message associated with the transaction. The server 130 may transmit the transaction information, the first fraud analysis results and the first risk score in the ISO 20022 standard message to the second device 120 associated with a disbursing agent.

At step 240, the second device 120 may perform a second fraud analysis. The second fraud analysis may include previous suspicious remittance to the money receiver; and entity link analysis. The entity link analysis can discover any hidden relationships between parties that seem disparate but are somehow interrelated based on demographic profiles. The entity link analysis can also help analyze transaction patterns and detect mule account schemes, thus preventing money laundering. The second device 120 may generate a second risk score for the transaction and the money receiver based on the second fraud analysis. The second device 120 may write the second risk score and the second fraud analysis back to the ISO 20022 transaction message.

At step 245, the second device 120 may transmit the second risk score back to the server 130. At step 250, the server 130 may store the first risk score and the second risk score on the database 140.

When the money receiver wants to receive the money, the money receiver may present the transaction identifier to the disbursing agent. The second device 120 may transmit the transaction identifier to the server 130. Accordingly, at step 255, the server 130 can receive the transaction identifier from the second device 120.

The server 130 may determine whether to approve the transaction based on the first risk score, the second risk score, the first fraud analysis and/or the second fraud analysis. In a case the server 130 approves the transaction, at step 260, the server 130 can transmit a transaction approval message to the second device 120. The disbursing agent can then release the money to the money receiver.

As described, the new ISO 20022 standard is able to pass fraud information through the transaction chain among multiple entities from one country to another country. More information can be included in the actual transactions to reduce fraud. This can use data that is collected at different points in the transaction chain to confirm other data that was submitted by different parties in the actual transaction chain. For example, the originating agent can use the first device 110 to collect the geo-location of the originating agent, information on whether the transaction is a physical in-person transaction, the IP address of an application associated with the transaction, the browser language, the unique ID associated with the device at the originating agent, the account data of the money sender, the name, address and phone number associated with the money sender, recent account changes, size of recent remittances, information on whether this is consistent with the amount of money that the money sender sends on a regular basis, information on whether it is a reoccurring transfer, KYC due diligence at regular intervals, and so on. For example, a recent transmittance, or a reoccurring transmittance can actually be a positive sign that this transaction is a valid transaction.

The money transfer operator has an ongoing relationship with the originating agent and the disbursing agent. There are transaction identifiers and transaction information that get passed between them. The present disclosure can increase the amount of data being passed with this fraud information. The present disclosure can track the reliability of the fraud rates associated with these entities and can pass this information back and forth through the ISO 20022 standard. The ISO 20022 standard is a more robust standard because it allows to provide more detailed metadata—in this case it is about the fraud metadata. The present disclosure can create an aggregate risk score for the customers (e.g., the first risk score and/or the second risk score above). If it is a high-risk transaction based on the aggregate risk score, extra step-up or proof of identity can be requested for the money receiver. The money transfer operator can perform anti-money laundering checks to be able to reduce their exposure. The money transfer operator also can look for different fraud identifiers, such as whether the money sender has a past SARs associated with them. A machine learning model can be used to detect anomalous patterns, compare to see the customers' peer group and their past transactions, check other money senders that were sending from this particular originating agent, and then compare to see if there have anomalous transactions based on other people that are sending from this particular originating agent.

The disbursing agent can know if there have been previous remittance issues with this particular money receiver. The disbursing agent can perform an entity link analysis for potentially preventing remittance fraud. For example, the entity link analysis can detect whether the same amount of money is sent by multiple people from the same originating agent, whether the same amount of money is coming in on a regular basis, and/or whether the money is divided across different sending people but for the same money receiver. This can provide an indication if there have a potential money laundering activity as part of this transaction. Each money receiver can also be assigned an ongoing risk sore for preventing anti-money laundering. All this data can be shared through the transaction chain and can be aggregated. All this data can be fed into a machine learning model to determine whether there is a series of mule activities here, or if there is fraud being committed during the transaction chain.

If the money sender is suspected to be fraudulent, the transaction can be slowed as it goes through, so further research can be performed on that customer, or run their information against the machine learning model. The money receiver can also be required to provide proof to demonstrate that they are who they say.

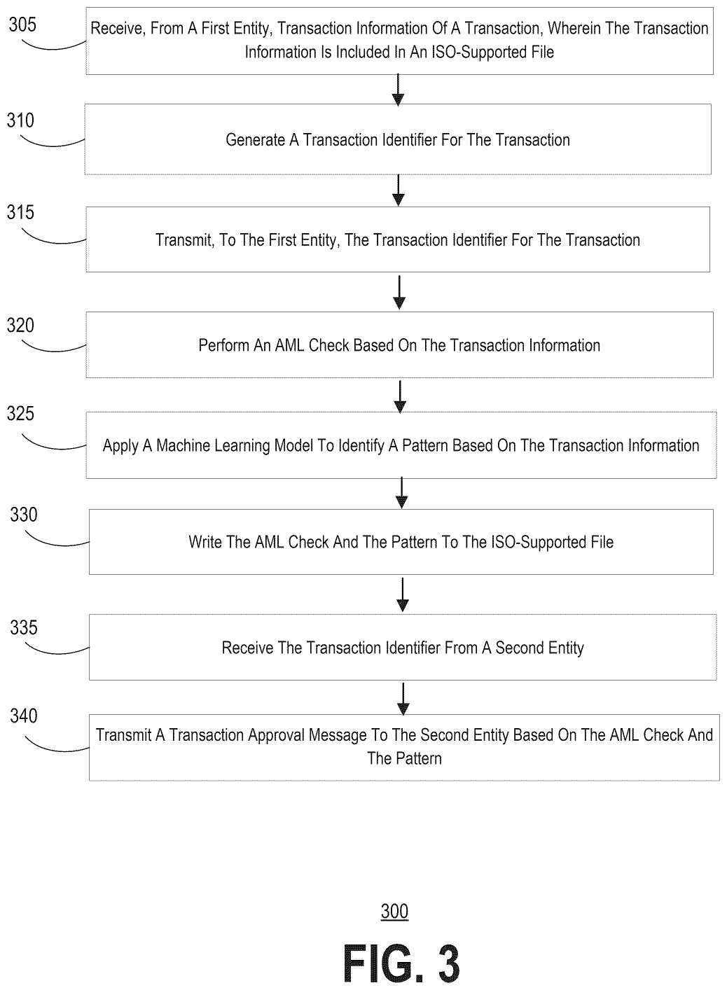

FIG. 3 illustrates a flow chart of an example method 300 of fraud prevention for cross-border transactions according to an example embodiment. FIG. 3 may reference the same or similar components as those illustrated in FIGS. 1-2, including a first device, a server, a database, and a second device. The method 300 can be implemented in the system 100 and may include, but is not limited to the following steps.

At step 305, the server 130 may receive, from a first entity, transaction information of a transaction. The transaction information may be included in an International Organization for Standardization (ISO)-supported file. The first entity can be an originating agent that uses the first device 110 to collect the transaction information and fund from a money sender. The transaction information can include, but not limited to, the geo-location of the originating agent, information on whether the transaction is a physical in-person transaction, the IP address of an application associated with the transaction, the browser language of the first device 110, the unique ID associated with a device at the originating agent, the account data of the money sender, the name, address and phone number associated with the money sender, recent account changes, size of recent remittances, information on whether this is consistent with the amount of money that the money sender sends on a regular basis, information on whether it is a reoccurring transfer, KYC due diligence at regular intervals, and so on.

At step 310, the server 130 may generate a transaction identifier for the transaction. The transaction identifier can be used to identify the transaction information and the fund received from the money sender.

At step 315, the server 130 may transmit, to the first entity, the transaction identifier for the transaction. The server 130 transmits the transaction identifier to the originating agent via the first device 110. The originating agent can then provide the transaction identifier to the money sender as a receipt of the transaction. The money sender may further transmit the transaction identifier to a money receiver who is indicated as the transferred fund receiver.

At step 320, the server 130 may perform an anti-money laundering (AML) check based on the transaction information. The AML check may also be based on fraud data associated with the originating agent and/or the money sender retrieved from the database 140 that may store past fraud data.

At step 325, the server 130 may apply a machine learning model to identify a pattern based on the transaction information and/or the fraud data retrieved from the database 140. The machine learning model can be configured to look for patterns indicating mule accounts, unusual transaction volumes, transactions inconsistent with customer profiles, and customers with a past SAR/STR marked history. The machine learning models can detect and report anomalous patterns against customers' peer groups and past transaction history and provide a flag on these accounts as well as using the fraud data provided in the ISO 20022 transaction message. The server 130 may generate a first risk score for the money sender and the transaction based on the AML check and the machine learning model.

At step 330, the server 130 may write the AML check and the detected pattern and/or the first risk score to the ISO-supported file, that is, the ISO 20022 transaction message associated with the transaction.

At step 335, the server 130 may receive the transaction identifier from a second entity. The second entity can be the disbursing agent who can use the second device 120 to transmit the transaction identifier after receiving it from the money receiver.

At step 340, the server 130 may transmit a transaction approval message to the second entity based on the AML check and the detected pattern. Based on the AML check, the detected pattern by the machine learning model and/or the first risk score, the server 130 can determine whether the transaction is a legitimate transaction. If the transaction can be determined as a legitimate transaction, the server 130 can transmit the transaction approval message to the second device 120 associated with the second entity. The disbursing agent can also perform further authentication of the money receiver. The disbursing agent can then release the transferred fund to the money receiver.

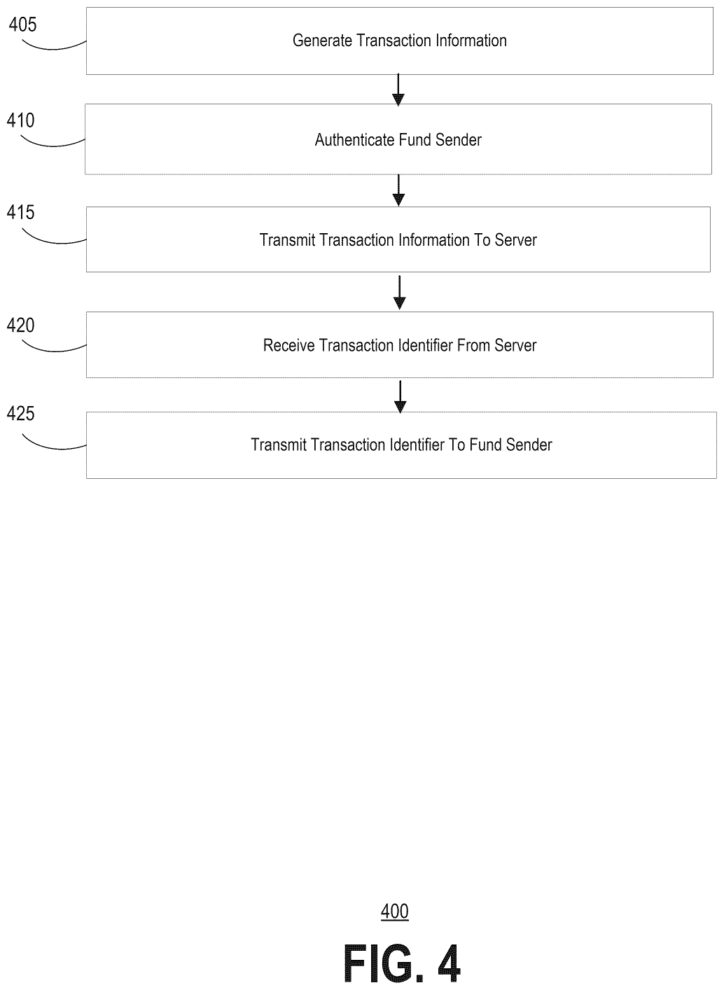

FIG. 4 illustrates a flow chart of an example method 400 of fraud prevention for cross-border according to an example embodiment. FIG. 4 may reference the same or similar components as those illustrated in FIGS. 1-3, including a first device, a server, a database, and a second device. The method 400 can be implemented in the system 100 and may include, but is not limited to the following steps.

At step 405, the originating agent may generate and/or collect through the first device 110 transaction information associated with the transaction. For example, when the money/fund sender want to perform the transaction of sending money to the money receiver, the originating agent can use the first device 110 to collect the geo-location of the originating agent, information on whether the transaction is a physical in-person transaction, the IP address of an application associated with the transaction, the browser language of the first device 110, the unique ID associated with a device at the originating agent, the account data of the money sender, the name, address and phone number associated with the money sender, recent account changes, size of recent remittances, information on whether this is consistent with the amount of money that the money sender sends on a regular basis, information on whether it is a reoccurring transfer, KYC due diligence at regular intervals, and so on.

At step 410, the originating agent may authenticate the money sender. The originating agent may ask the money sender to provide a physical identification such as a driver's license, may send to a device of the money sender a one-time passcode and then ask the money sender to provide the one-time passcode.

At step 415, upon authenticating the money sender, the originating agent may use the first device 110 to transmit the transaction information to the server 130 associated with the money transfer operator. The originating agent may write the transaction information into the ISO 20022 transaction message and then transmit the ISO 20022 transaction message to the server 130.

After receiving the ISO 20022 transaction message including the transaction information, the money transfer operator may generate a transaction identifier for the transaction and transmit via the server 130 the transaction identifier to the first device 110 of the originating agent. Accordingly, at step 420, the first device 110 of the originating agent may receive the transaction identifier from the server 130.

At step 425, the first device 110 of the originating agent may transmit the transaction identifier to the money sender. The money sender may then transmit the transaction identifier to the money receiver. The money receiver can use the transaction identifier as an identification for receiving the transferred money from the disbursing agent.

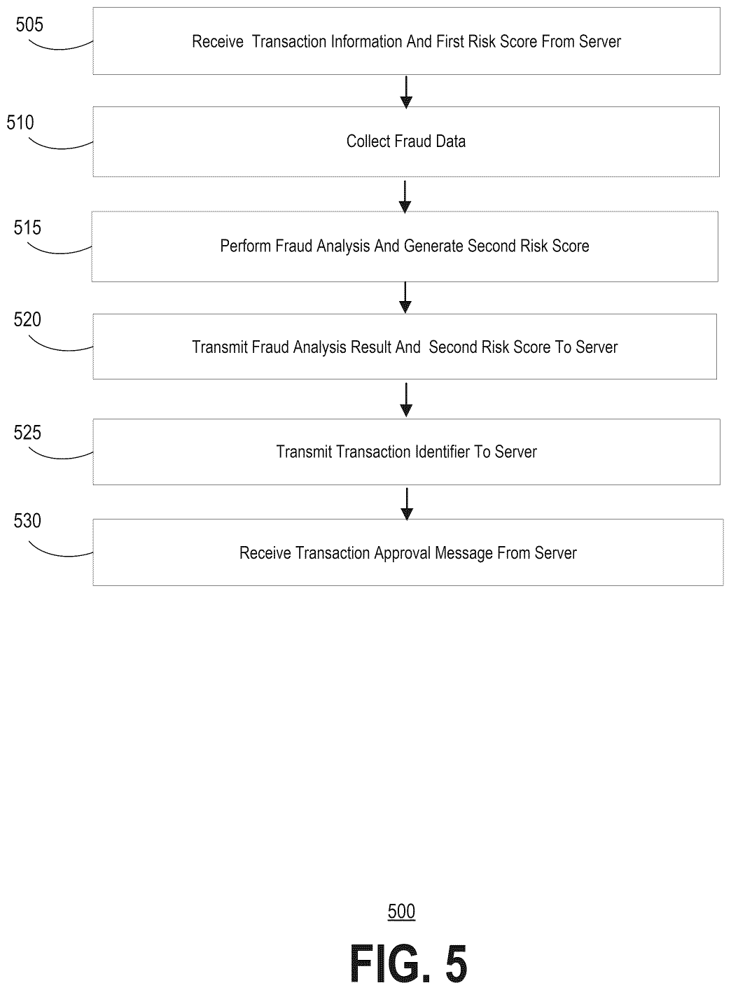

FIG. 5 illustrates a flow chart of an example method 500 of fraud prevention for cross-border transactions according to an example embodiment. FIG. 5 may reference the same or similar components as those illustrated in FIGS. 1-4, including a first device, a server, a database, and a second device. The method 500 can be implemented in the system 100 and may include, but is not limited to the following steps.

At step 505, the second device 120 of the disbursing agent may receive the transaction information and a first risk score included in the ISO 20022 transaction message from the server 130 of the money transfer operator. As described above, the server 130 may generate the first risk score based on the transaction information and/or further fraud data retrieved from the database 140, and transmit the first risk score to the second device 120.

At step 510, the second device 120 of the disbursing agent may collect further fraud data associated with the money receiver and/or the money sender. For example, the further fraud data may include previous suspicious remittance associated with the money receiver and/or the money sender.

At step 515, the second device 120 associated with the disbursing agent can perform a fraud analysis and generate a second risk score associated with the transaction, money sender and/or money receiver. For example, the second device 120 may perform an entity link analysis to detect whether the same amount of money is sent by multiple people from the same originating agent, whether the same amount of money is coming in on a regular basis, and/or whether the money is divided across different sending people but for the same money receiver. This can provide an indication if there have a potential money laundering activity as part of this transaction. Each money receiver can also be assigned an ongoing risk sore for preventing anti-money laundering. All this data can be shared through the transaction chain and can be aggregated. All this data can be fed into a machine learning model to determine whether there is a series of mule activities here, or if there is fraud being committed during the transaction chain.

At step 520, the second device 120 may write the fraud analysis result and the second risk score into the ISO 20022 transaction message and transmit it back to the server 130.

At step 525, upon receiving the transaction identifier from the money receiver, the second device 120 may transmit the transaction identifier to the server 130 for requesting the release of the transferred money.

Upon receiving the transaction identifier from the second device 120, the server 130 may determine whether to release the transferred money based on the AML check result, the transaction pattern generated by the machine learning model, the first risk score, the fraud analysis result received from the second device 120, and/or the second risk score. If the server 130 determines to release the transferred money, the server 130 may transmit a transaction approval message to the second device 120. Accordingly, at step 530, the second device 120 can receive the transaction approval message from the server 130, and release the transferred money to the money receiver.

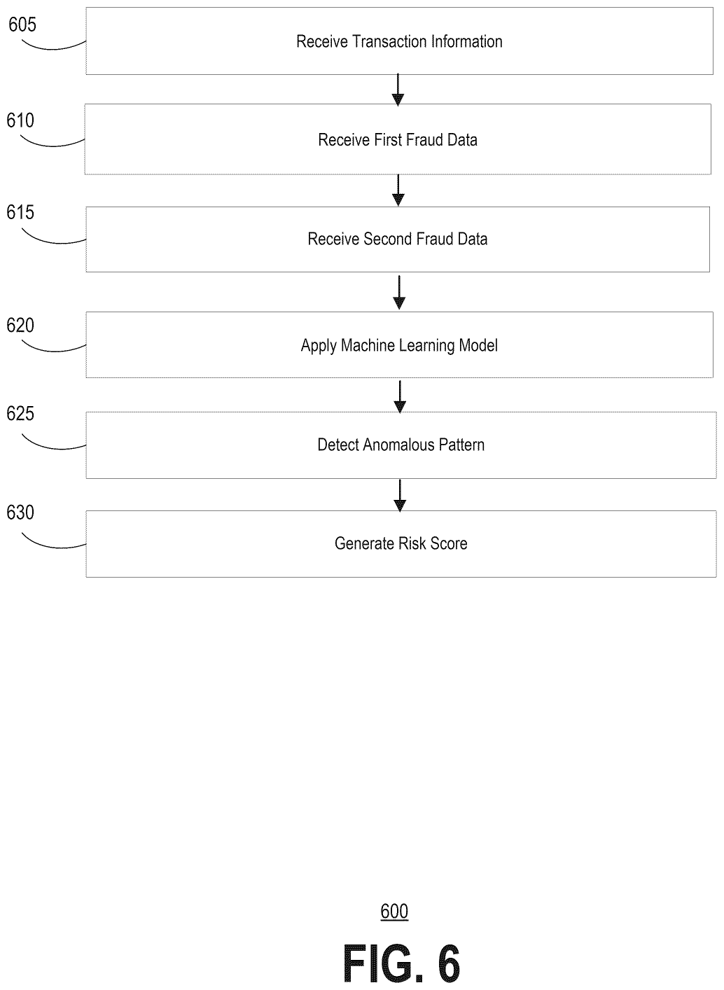

FIG. 6 illustrates a flow chart of an example method 600 of fraud prevention for cross-border transactions using a machine learning model according to an example embodiment. FIG. 6 may reference the same or similar components as those illustrated in FIGS. 1-5, including a first device, a server, a database, and a second device. The method 600 can be implemented in the system 100 and may include, but is not limited to the following steps.

At step 605, a machine learning model can receive through the server 130 from the first device 110 transaction information included in the ISO 20022 transaction message. The transaction information can include the geo-location of the originating agent, information on whether the transaction is a physical in-person transaction, the IP address of an application associated with the transaction, the browser language of the first device 110, the unique ID associated with a device at the originating agent, the account data of the money sender, the name, address and phone number associated with the money sender, recent account changes, size of recent remittances, information on whether this is consistent with the amount of money that the money sender sends on a regular basis, information on whether it is a reoccurring transfer, KYC due diligence at regular intervals, and so on.

At step 610, the machine learning model can receive through the server 130 from the database 140 first fraud data. The first fraud data can include anti-money laundering (AML) check results, mule accounts, unusual transaction volumes, transactions inconsistent with customer profiles, and past SAR/STR marked history.

At step 615, the machine learning model can receive through the server 130 from the second device 120 second fraud data. The second fraud data can include previous suspicious remittance associated with the money receiver and/or the money sender.

At step 620, the machine model is applied to get trained and predict based on the first and second fraud data. For example, the machine learning model can be trained using past fraud data to tune the model parameters of the machine learning model to produce a more accurate model.

At step 625, the machine learning model can detect anomalous transaction pattern. For example, the machine learning model can look for patterns indicating mule accounts, unusual transaction volumes, transactions inconsistent with customer profiles, and customers with a past SAR/STR marked history. The machine learning models can detect and report anomalous patterns against customers' peer groups and past transaction history and provide a flag on these accounts.

At step 630, the machine learning model can generate a risk score (such as the first risk score) for the transaction or the money sender. The server 130 and/or the second device 120 may determine whether the transaction is associated with an AML based on the risk score.

The machine learning models described herein can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

The machine learning models described herein can utilize various neural networks, such as convolutional neural networks (CNNs) or recurrent neural networks (RNNs), to generate the exemplary models. A CNN can include one or more convolutional layers (e.g., often with a subsampling step) and then followed by one or more fully connected layers as in a standard multilayer neural network. CNNs can utilize local connections, and can have tied weights followed by some form of pooling which can result in translation invariant features.

A RNN is a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. A RNN can generally refer to two broad classes of networks with a similar general structure, where one is finite impulse and the other is infinite impulse. Both classes of networks exhibit temporal dynamic behavior. A finite impulse recurrent network can be, or can include, a directed acyclic graph that can be unrolled and replaced with a strictly feedforward neural network, while an infinite impulse recurrent network can be, or can include, a directed cyclic graph that may not be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory, and can be part of long short-term memory networks (LSTMs) and gated recurrent units.

RNNs can be similar to a network of neuron-like nodes organized into successive “layers,” each node in a given layer being connected with a directed e.g., (one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data en route from input to output). RNNs can accept an input vector x and give an output vector y. However, the output vectors are based not only by the input just provided in, but also on the entire history of inputs that have been provided in in the past.

For supervised learning in discrete time settings, sequences of real-valued input vectors can arrive at the input nodes, one vector at a time. At any given time step, each non-input unit can compute its current activation (e.g., result) as a nonlinear function of the weighted sum of the activations of all units that connect to it. Supervisor-given target activations can be supplied for some output units at certain time steps. For example, if the input sequence is a speech signal corresponding to a spoken digit, the final target output at the end of the sequence can be a label classifying the digit. In reinforcement learning settings, no teacher provides target signals. Instead, a fitness function, or reward function, can be used to evaluate the RNNs performance, which can influence its input stream through output units connected to actuators that can affect the environment. Each sequence can produce an error as the sum of the deviations of all target signals from the corresponding activations computed by the network. For a training set of numerous sequences, the total error can be the sum of the errors of all individual sequences.

The models described herein may be trained on one or more training datasets, each of which may comprise one or more types of data. In some examples, the training datasets may comprise previously-collected data, such as data collected from previous uses of the same type of systems described herein and data collected from different types of systems. In other examples, the training datasets may comprise continuously-collected data based on the current operation of the instant system and continuously-collected data from the operation of other systems. In some examples, the training dataset may include anticipated data, such as the anticipated future workloads, currently scheduled workloads, and planned future workloads, for the instant system and/or other systems. In other examples, the training datasets can include previous predictions for the instant system and other types of system, and may further include results data indicative of the accuracy of the previous predictions. In accordance with these examples, the machine learning models described herein may be training prior to use and the training may continue with updated data sets that reflect additional information.

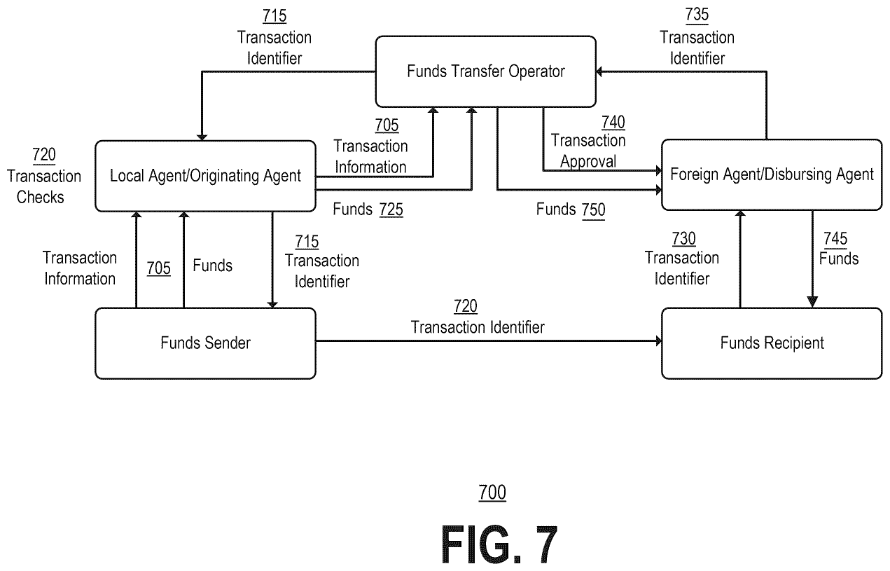

FIG. 7 illustrates a diagram of a system 700 of fraud prevention for cross-border transactions according to an example embodiment. The system 700 may comprise a first device associated with an originating agent or local agent, a server associated with a funds transfer operator, and a second device associated with a disbursing agent or foreign agent.

In the system 700, at block 705, a funds sender arranges with a local agent, e.g., an originating agent, to remit funds and provide transaction information. The transaction information can include information relating to the funds sender (e.g., sender's name, address, possibly date of birth), information relating to the funds recipient's details (recipient's name) and the transaction amount. The local agent or originating agent can perform any checks as required, e.g., checks required under local anti-funds laundering and counter terrorist financing laws, at step 710. The agent then transmits the transaction information to the funds transfer operator (FTO).

At step 715, the FTO can transmit to the local agent or originating agent a unique transaction identifier. The local agent or originating agent can transmit the unique transaction identifier to the funds sender.

At step 720, the funds sender can transmit to the funds recipient the unique transaction identifier.

At step 725, the funds can be wired from the local agent or originating agent to the FTO. The timing of this depends on what is contractually agreed between the FTO and the agent, e.g., end of the day of the transaction or one or more days after the transaction.

In the receiving country, at step 730, the funds recipient can provide the unique transaction identifier to the to the foreign agent or disbursing agent. The foreign agent or disbursing agent can transmit the transaction identifier to the FTO at step 735.

At step 740, if approved, the FTO can transmit a transaction approval to the foreign agent or disbursing agent. At step 745, having received the transaction approval, the foreign agent or disbursing agent can pay out funds to the funds recipient. At step 750, the FTO can settle the transaction with the foreign agent or disbursing agent.

In some embodiments, the FTO can consist of one or more international companies, which provide a global remittance service involving a worldwide network of agents, automated teller machines (ATMs), and electronic channels and a large range of smaller institutions that specialize in sending funds across particular migration corridors or via digital channels.

The diagram of the system 700 can provide a schematic illustration of the funds transfer process, with the sequencing of transactions and actions indicated. It illustrates the importance of both transaction information flows and monetary flows, as well as the need for cooperation and trust between the FTO and its domestic and foreign agents involved in receiving and paying out funds.

In most cases the remittance process occurs in three phases, the funds capture phase, the funds disbursement phase and the communications and settlement phase. In the funds capture phase an individual goes to the FTO and provides funds to be transferred to a third party overseas. In the funds disbursement phase the FTO pays out the funds to the recipient through one of their agents or branches in the receiving country.

In the settlement stage of the international remittance process the FTO settles the transaction involving different currencies across borders. Lags between fixing the exchange rate for the customer and undertaking the corresponding foreign exchange transactions create risks for FTOs which can either be hedged or the risk assumed on their own trading accounts. Compensation for that risk-bearing may be reflected in fees charged to customers.

In some aspects, the techniques described herein relate to a system for performing cross-border transactions, including a computer server including a memory and a processor, wherein the server is configured to: receive, from a first entity, transaction information of a transaction, wherein the transaction information is included in an International Organization for Standardization (ISO)-supported file; generate a transaction identifier for the transaction; transmit, to the first entity, the transaction identifier for the transaction; perform an anti-money laundering (AML) check based on the transaction information; apply a machine learning model to identify a pattern based on the transaction information; write the AML check and the pattern to the ISO-supported file; receive the transaction identifier from a second entity; and transmit a transaction approval message to the second entity based on the AML check and the pattern.

In some aspects, the techniques described herein relate to a system, wherein the first entity is an originating agent.

In some aspects, the techniques described herein relate to a system, wherein the originating agent is one selected from the group consisting of a bank, a payment service provider (PSP), a third party payment PSP (TPP-PSP), a payment on behalf of (POBO) corporation, or a collection on behalf of (COBO) corporation.

In some aspects, the techniques described herein relate to a system, wherein the ISO-supported file is an ISO-20022-supported file.

In some aspects, the techniques described herein relate to a system, wherein the transaction information includes one or more selected from the group consisting of an internet protocol (IP) address associated with the transaction, a geo-location associated with transaction, a browser language, or a unique device identification (ID) that started the transaction with the first entity.

In some aspects, the techniques described herein relate to a system, wherein the transaction information further includes one or more associated with the transaction and selected from the group consisting of a name, an email, a phone number, recent account changes and account age, historical transactions and velocity metrics, size of recent remittances, an identification of the transaction as a recurring transfer, and performance of a know your client (KYC) due diligence at regular intervals and rate one or more customers based on a risk associated with the one or more customers.

In some aspects, the techniques described herein relate to a system, wherein the first entity is configured to perform an initial authentication and funds collection associated with the transaction.

In some aspects, the techniques described herein relate to a system, wherein the server is configured to generate a fraud rate associated with the first entity.

In some aspects, the techniques described herein relate to a system, wherein the server is configured to write the fraud rate to the ISO-supported file.

In some aspects, the techniques described herein relate to a system, wherein the pattern indicates one or more of mule accounts, unusual transaction volumes, transactions inconsistent with customer profiles, and customers with a past suspicious activity report (SAR) marked history.

In some aspects, the techniques described herein relate to a system, wherein the server is configured to provide a flag on the transaction when the pattern is an anomalous pattern.

In some aspects, the techniques described herein relate to a method for performing cross-border transactions, including: receiving, from a first entity, transaction information of a transaction, wherein the transaction information is included in an International Organization for Standardization (ISO)-supported file; generating a transaction identifier for the transaction; transmitting, to the first entity, the transaction identifier for the transaction; performing an anti-money laundering (AML) check based on the transaction information; applying a machine learning model to identify a pattern based on the transaction information; writing the AML check and the pattern to the ISO-supported file; receiving the transaction identifier from a second entity; and transmitting a transaction approval message to the second entity based on the AML check and the pattern.

In some aspects, the techniques described herein relate to a method, wherein the second entity is a disbursing agent.

In some aspects, the techniques described herein relate to a method, wherein the disbursing agent is one selected from the group consisting of a bank, a payment service provider (PSP), a third party payment PSP (TPP-PSP), a payment on behalf of (POBO) corporation, or a collection on behalf of (COBO) corporation.

In some aspects, the techniques described herein relate to a method, wherein the ISO-supported file is an ISO8583-supported file.

In some aspects, the techniques described herein relate to a method, further including generating a fraud rate associated with the second entity.

In some aspects, the techniques described herein relate to a method, further including the fraud rate in the ISO-supported file.

In some aspects, the techniques described herein relate to a method, wherein the pattern is an anomalous patterns against customers' peer groups and past transaction history.

In some aspects, the techniques described herein relate to a method, wherein the second entity is configured to: provide information on one or more of previous suspicious remittance to a receiver of the transaction, and entity link analysis; write the provided information back to the ISO-supported file; and assign an ongoing risk score to the receiver.

In some aspects, the techniques described herein relate to a non-transitory, computer-readable medium including instructions for performing cross-border transactions that, when executed on a computer arrangement, cause the computer arrangement to perform actions including: receiving, from a first entity, transaction information of a transaction, wherein the transaction information is included in an International Organization for Standardization (ISO)-supported file; generating a transaction identifier for the transaction; transmitting, to the first entity, the transaction identifier for the transaction; performing an anti-money laundering (AML) check based on the transaction information; applying a machine learning model to identify a pattern based on the transaction information; writing the AML check and the pattern to the ISO-supported file; receiving the transaction identifier from a second entity; and transmitting a transaction approval message to the second entity based on the AML check and the pattern.

As used herein, the terms “bank” and “agent” are not limited to a particular bank, type of bank, particular agent, or type of agent. Rather, it is understood that the terms “bank” and “agent” can refer to any type of bank, agent, account and/or card issuer, or other entity involved in the creation, issuance, or provisioning of accounts or cards associated with accounts and/or in the processing of transactions.

As used herein, the term “account” is not limited to a particular type of account. Rather, it is understood that the term “account” can refer to a variety of accounts, including without limitation, a financial account (e.g., a credit account, a debit account), a membership account, a loyalty account, a subscription account, a services account, a utilities account, a transportation account, and a physical access account. It is further understood that the present disclosure is not limited to accounts issued by a particular entity.

As used herein, the term “card” is not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

As used herein, the term “merchant” is not limited to a particular merchant or type of merchant. Rather, it is understood that the term “merchant” can refer to any type of merchant, vendor, or other entity involved in activities where products or services are sold or otherwise provided.

In some examples, exemplary procedures in accordance with the present disclosure described herein can be performed by a processing arrangement and/or a computing arrangement (e.g., a computer hardware arrangement). Such processing and/or computing arrangement can be, for example entirely or a part of, or include, but not limited to, a computer/processor that can include, for example one or more microprocessors, and use instructions stored on a computer-accessible medium (e.g., RAM, ROM, hard drive, or other storage device). For example, a computer-accessible medium can be part of the memory of a first device, a user device, a server, or other computer hardware arrangement.

In some examples, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, and any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

Throughout the disclosure, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for performing cross-border transactions, comprising a computer server including a memory and a processor, wherein the server is configured to:
receive, from a first entity, transaction information of a transaction, wherein the transaction information is included in an International Organization for Standardization (ISO)-supported file;
generate a transaction identifier for the transaction;
transmit, to the first entity, the transaction identifier for the transaction;
perform an anti-money laundering (AML) check based on the transaction information;
apply a machine learning model to identify a pattern based on the transaction information;
write the AML check and the pattern to the ISO-supported file;
receive the transaction identifier from a second entity; and
transmit a transaction approval message to the second entity based on the AML check and the pattern.

2. The system according to claim 1, wherein the first entity is an originating agent.

3. The system according to claim 2, wherein the originating agent is one selected from the group consisting of a bank, a payment service provider (PSP), a third party payment PSP (TPP-PSP), a payment on behalf of (POBO) corporation, or a collection on behalf of (COBO) corporation.

4. The system according to claim 1, wherein the ISO-supported file is an ISO-20022-supported file.

5. The system according to claim 1, wherein the transaction information includes one or more selected from the group consisting of an internet protocol (IP) address associated with the transaction, a geo-location associated with transaction, a browser language, or a unique device identification (ID) that started the transaction with the first entity.

6. The system according to claim 5, wherein the transaction information further includes one or more associated with the transaction and selected from the group consisting of a name, an email, a phone number, recent account changes and account age, historical transactions and velocity metrics, size of recent remittances, an identification of the transaction as a recurring transfer, and performance of a know your client (KYC) due diligence at regular intervals and rate one or more customers based on a risk associated with the one or more customers.

7. The system according to claim 1, wherein the first entity is configured to perform an initial authentication and funds collection associated with the transaction.

8. The system according to claim 1, wherein the server is configured to generate a fraud rate associated with the first entity.

9. The system according to claim 8, wherein the server is configured to write the fraud rate to the ISO-supported file.

10. The system according to claim 1, wherein the pattern indicates one or more of mule accounts, unusual transaction volumes, transactions inconsistent with customer profiles, and customers with a past suspicious activity report (SAR) marked history.

11. The system according to claim 1, wherein the server is configured to provide a flag on the transaction when the pattern is an anomalous pattern.

12. A method for performing cross-border transactions, comprising:
receiving, from a first entity, transaction information of a transaction, wherein the transaction information is included in an International Organization for Standardization (ISO)-supported file;
generating a transaction identifier for the transaction;
transmitting, to the first entity, the transaction identifier for the transaction;
performing an anti-money laundering (AML) check based on the transaction information;
applying a machine learning model to identify a pattern based on the transaction information;
writing the AML check and the pattern to the ISO-supported file;
receiving the transaction identifier from a second entity; and
transmitting a transaction approval message to the second entity based on the AML check and the pattern.

13. The method according to claim 12, wherein the second entity is a disbursing agent.

14. The method according to claim 13, wherein the disbursing agent is one selected from the group consisting of a bank, a payment service provider (PSP), a third party payment PSP (TPP-PSP), a payment on behalf of (POBO) corporation, or a collection on behalf of (COBO) corporation.

15. The method according to claim 12, wherein the ISO-supported file is an ISO8583-supported file.

16. The method according to claim 12, further comprising generating a fraud rate associated with the second entity.

17. The method according to claim 16, further comprising including the fraud rate in the ISO-supported file.

18. The method according to claim 12, wherein the pattern is an anomalous patterns against customers' peer groups and past transaction history.

19. The method according to claim 12, wherein the second entity is configured to:
provide information on one or more of previous suspicious remittance to a receiver of the transaction, and entity link analysis;
write the provided information back to the ISO-supported file; and
assign an ongoing risk score to the receiver.

20. A non-transitory, computer-readable medium comprising instructions for performing cross-border transactions that, when executed on a computer arrangement, cause the computer arrangement to perform actions comprising:
receiving, from a first entity, transaction information of a transaction, wherein the transaction information is included in an International Organization for Standardization (ISO)-supported file;
generating a transaction identifier for the transaction;
transmitting, to the first entity, the transaction identifier for the transaction;
performing an anti-money laundering (AML) check based on the transaction information;
applying a machine learning model to identify a pattern based on the transaction information;
writing the AML check and the pattern to the ISO-supported file;
receiving the transaction identifier from a second entity; and
transmitting a transaction approval message to the second entity based on the AML check and the pattern.
